(19) United States
(12) Patent Application Publication
(10) Pub. No.: US 2026/0229588 A1
(43) Pub. Date: Aug. 6, 2026

(54) Semi-Solid Pouch Battery and Preparation Method Thereof

(71) Applicant: TIANNENG BATTERY GROUP CO., LTD., Huzhou, Zhejiang (CN)

(72) Inventors: Haiyuan ZHANG, Huzhou, Zhejiang (CN); Yu LI, Huzhou, Zhejiang (CN); Haimin ZHAO, Huzhou, Zhejiang (CN); Hao ZHANG, Huzhou, Zhejiang (CN); Guang HE, Huzhou, Zhejiang (CN); Yifei LU, Huzhou, Zhejiang (CN); Hongjie WANG, Huzhou, Zhejiang (CN); Kunguang HONG, Huzhou, Zhejiang (CN); Shuqiang WANG, Huzhou, Zhejiang (CN)

(21) Appl. No.: 19/147,994

(22) PCT Filed: Apr. 17, 2023
(86) PCT No.: PCT/CN2023/088678

§ 371 Date: Jul. 14, 2025

(30) Foreign Application Priority Data
Jan. 16, 2023 (CN) 202310106482.8

(51) Int. Cl. H01M 10/056; H01M 50/105

(52) U.S. Cl. CPC H01M 10/056; H01M 50/105; H01M 2300/0085; H01M 2300/0091

(57) ABSTRACT

Provided are a semi-solid pouch battery and a preparation method thereof. According to the defects of high gas production, synchronous solidified bubbles, low initial coulombic efficiency, poor cycling performance, and the like of an existing in-situ polymerization lithium-ion pouch battery obtained through one-step liquid injection polymerization, a process route of adding steps, such as secondary liquid injection, etc., is provided for a semi-solid lithium-ion pouch battery, for which an in-situ polymerization method is used, such that an electrolyte solution is fully formed before in-situ polymerization and is fully reacted, full production and exhaustion of gases are realized, and the aims of achieving bubble-free solidifying, improving the initial coulombic efficiency, and improving the cycling performance of a cell are achieved. By means of the above method, and a semi-solid lithium-ion battery meeting the requirements of a real scenario may be produced.

### CROSS-REFERENCE TO RELATED APPLICATION(S)

The present application is a National Stage of International Application No. PCT/CN2023/088678 filed on Apr. 17, 2023, which claims the benefit of priority of Chinese Patent Application No. 202310106482.8, filed on 16 Jan. 2023, the entire contents of each of which are incorporated herein by reference in their entireties.

### TECHNICAL FIELD

The present disclosure belongs to the technical field of secondary batteries, and in particular, to a semi-solid pouch battery and a preparation method thereof.

### BACKGROUND

The electrolyte solution is an important component of a lithium-ion battery. All electrolyte solutions currently used are organic compounds, which cause problems such as leakage, combustion, and the like under extreme use conditions. In order to solve lithium battery safety problems, all-solid electrolytes have been widely researched. The all-solid electrolytes can improve the safety of the batteries. However, all-solid lithium-ion batteries have high interface impedance, and poor rate and cycling performance. Existing technologies are not yet mature and cannot meet current use requirements.

Gel electrolytes commonly used in semi-solid batteries combine the excellent ionic conductivity of liquid electrolytes with the safety performance of all-solid electrolytes, and may be produced on existing lithium-ion battery production devices, reducing device and factory investment, such that the gel electrolytes are widely researched at major research institutions and large lithium-ion battery companies. Many gel electrolytes are prepared by using in-situ polymerization methods. Researchers often refer to an in-situ polymerization technology as an in-situ solidification technology, which typically injects a liquid monomer into a cell in a liquid injection manner and then initiates monomer polymerization under certain conditions after soaking, so as to form an in-situ solidified battery. For example, provided in Chinese Patent Application with publication number CN105914405A is an integrated all-solid polymer battery that is formed by injecting a liquid epoxy compound and a lithium salt in a battery and then initiating in-situ open-loop solidification under a heating condition. In Chinese Patent Application with publication number CN108493486A, acrylate and an initiator are dissolved in an electrolyte solution and injected in a battery, and unsaturated double bond polymerization is initiated under a heating condition, so as to form an integrated gel polymer battery. In Chinese Patent Application with publication number CN111533851A, small molecule carbonate containing double bonds, ethylene glycol acrylate, and an initiator are mixed and injected at an interface of a solid battery, and an electrode-electrolyte integrated all-solid battery is formed through thermal-initiation polymerization. In Chinese Patent Application with publication number CN111540956A, isocyanic acid and polypropylene glycol are dissolved in an electrolyte solution and then injected in a battery to form an integrated battery through electropolymerization, thereby reducing electrode-electrolyte interface impedance.

Moreover, there are different ways to prepare the batteries by using the in-situ polymerization method. For example, in Chinese Patent Application with publication number CN110048158A, a casting method is used to form a double-layer structure electrolyte membrane with one side being ester and the other side being ether through in-situ polymerization on both sides of a porous membrane. The membrane meets the stability requirements of both high-pressure positive electrodes and low-pressure negative electrodes. In Chinese Patent Application with publication number CN110581314A, an inorganic solid electrolyte is coated on a support separator and a positive electrode contact side, and a polymer electrolyte is coated on the support separator and a negative electrode contact side, such that electrolyte oxidation is reduced, and the safety and cycling stability of a battery are improved. However, the multi-layer composite film processes currently reported are complex, mostly including performing coating outside a cell to form a film, and then combining same with an electrode plate. The contact between the electrolyte and the electrode interface is poor, resulting in high impedance, thereby not facilitating the full utilization of the capacity of the battery. In Chinese Patent Application with publication number CN114335716A, a reactive monomer is mixed in a positive electrode and a negative electrode, and reaction aids such as a crosslinking agent are added in an electrolyte solution for in-situ polymerization.

Comprehensively considering factors affecting the industrialization of lithium batteries, such as compatibility with existing lithium-ion batteries, cost, convenience of device modification, and the like, regardless of how the method of preparing a battery through in-situ polymerization changes, the liquid injection process, the in-situ polymerization process, and the like remain indispensable. Furthermore, in-situ polymerization after direct liquid injection is the simplest and most convenient method for battery preparation. However, the study of researchers on in-situ polymerization focuses more on the structure of materials and polymerization reactions, with little research performed on actual industrial processes for semi-solid batteries, such as liquid injection and the like. Process problems occurring during industrialization, such as severe gas production, uneven polymerization, and low initial coulombic efficiency, are also rarely solved with solutions.

### SUMMARY

In order to solve the above problems, an industrialized interface-free semi-solid pouch battery production process having a three-dimensional network electrolyte is proposed.

A method for preparing a semi-solid pouch battery. The semi-solid pouch battery includes a dry battery cell. The preparation method includes the following steps:
(1) First liquid injection is performed in a dry battery cell, and an electrolyte solution precursor I is injected, where the electrolyte solution precursor I includes a reactive monomer, a crosslinking agent, a small molecule plasticizer, and a lithium salt;
(2) First formation is performed, and then first gas exhaustion is performed;
(3) Second liquid injection is performed, and an electrolyte solution precursor II is injected, where the electrolyte solution precursor II includes an initiator and a small molecule plasticizer, and includes or does not include a lithium salt; and the reactive monomer and the crosslinking agent undergo in-situ polymerization under the action of the initiator; and
(4) Second formation is performed, and then second gas exhaustion is performed.

The reactive monomer is an organic reactive monomer that contains a double bond or a cyclic functional group and may undergo free radical polymerization to form a high-molecular long-chain polymer with a freely movable chain segment.

The initiator is an azo initiator, a peroxide initiator, or a cationic and anionic initiator that initiates radical polymerization of the reactive monomer.

The crosslinking agent is an organic compound that contains bifunctional or multifunctional groups and may bind with a free radical reactive monomer.

The reactive monomer includes at least one of the following: vinyl acetate, dimethyl allyl dicarboxylate, diethyl allylmalonate, dimethallyl carbonate, 1,4-butanediol diacrylate, hexamethylene diacrylate, methyl methacrylate, butyl methacrylate, vinylene carbonate, 4-vinyl-1,3-dioxolan-2-one, methyl vinyl sulfone, ethyl vinyl sulfone, ethoxylated trimethylolpropane triacrylate, pentaerythritol triacrylate, pentaerythritol tetraacrylate, dipentaerythritol hexaacrylate, dipentaerythritol hexaacrylate, acrylamide, N,N-methylenebisacrylamide, caprolactam, 2-pyrrolidinone, acrylonitrile, 2-carbonitrile ethyl acrylate, 2-carbonitrile-2-butyl acrylate, 2-carbonitrile-3,3-isooctyl diphenyl acrylate, 1-cyclohexene-1-acetonitrile, hexafluorobutyl methacrylate, trifluoroethyl methacrylate, poly(ethylene glycol) methacrylate, polyethylene glycol dimethacrylate, poly(ethylene glycol) diacrylate, ethoxyethyl acrylate, polyethylene glycol, 1,3-dioxolane, 1,4-dioxane, vinylmethoxysilane, 2-(trimethylsiloxy)ethyl methacrylate, triethylcyclotriosiloxane, or tri(2-methoxyethoxy)vinylsilane.

The crosslinking agent includes at least one of the following: poly(ethylene glycol) diacrylate, poly(ethylene glycol) dimethacrylate, trimethylolpropane trimethacrylate, pentaerythritol tetraacrylate, pentaerythritol triacrylate, ethoxylated trimethylolpropane triacrylate, or polyether polyacrylate.

The initiator includes at least one of the following: 2,2′-azobis(2-methylpropionitrile), 2,2′-azobis(2,4-dimethyl)valeronitrile, dimethyl 2,2′-azobis(2-methylpropionate), benzoyl peroxide, tert-butyl peroxybenzoate, 2-butanone peroxide, aluminum trifluoromethanesulfonate, magnesium trifluoromethanesulfonate, lithium bis(fluorosulfonyl)imide, or tin trifluoromethanesulfonate.

The lithium salt includes at least one of the following: LiBF₄, LiBF₆, LiAsF₆, LiPF₆, LiClO₄, LiFSI, LiTFSI, LiB(C₆H₅)₄, LiAlCl₄, LiBr, LiCF₃SO₃, LiN(CF₃SO₂)₂, or LiC(CF₃SOSO₂)₃.

The small molecule plasticizer includes at least one of the following: ethylene carbonate, propylene carbonate, ethyl methyl carbonate, diethyl carbonate, dimethyl carbonate, fluorinated ethylene carbonate, dipropyl carbonate, dimethyl sulfoxide dimethoxyethane, N-methyl-2-pyrrolidone, 7-butyrolactone, or polyethylene glycol dimethyl ether.

Preferably, a mass fraction of the reactive monomer in the electrolyte solution precursor I is 10% to 18%.

A mass fraction of the crosslinking agent in the electrolyte solution precursor I is 1% to 2.2%.

A mass fraction of the initiator in the electrolyte solution precursor II is 0.50% to 0.95%.

A mass fraction of the lithium salt in the electrolyte solution precursor I is 10% to 15%.

A mass fraction of the lithium salt in the electrolyte solution precursor II is 0% to 15%.

Other components in the precursor I and the precursor II are the small molecule plasticizers.

Preferably, the electrolyte solution precursor I and the electrolyte solution precursor II are added based on a mass ratio of (1.8~1.9):1.

Preferably, in step (3), a temperature during in-situ polymerization 60 to 90° C., a polymerization time is 0.1 to 72 h, and a polymerization pressure is controlled at 0.2 MPa to 500 MPa.

Conditions for first formation include: a charging current being 0.01 C to 0.33 C, and a charging time being 60 minutes to 120 minutes.

Conditions for second formation include: a charging current being 0.01 C to 0.5 C, and a charging cutoff voltage being a rated voltage.

Preferably, gas exhaustion times for first gas exhaustion and second gas exhaustion are 1 to 20 s, and a gas exhaustion vacuum degree is between −98 kPa and −20 kPa.

High-temperature aging is performed after first gas exhaustion, a high-temperature aging temperature is 45° C. to 80° C., and a time is 12 to 120 h.

Standing is performed after second gas exhaustion, and a standing time is 1-30 min.

Preferably, environmental dew points during first liquid injection and second liquid injection are controlled at −60° C. to −35° C., and a vacuum degree is −98 kPa to −20 kPa. Standing is performed at normal temperature for at least 48 h after first liquid injection, such that the electrolyte solution precursor I fully soaks a cell.

The above formula and process parameters are optimized conditions that are confirmed through a plurality of experiments, so as to ensure that the reactive monomer may be polymerized to meet electrical performance requirements of the cell. If the experiments are not performed according to the optimized conditions, the result may be that the reactive monomer cannot be polymerized/over-polymerized, or that the electrical performance of the cell deteriorates significantly.

The present disclosure further provides a semi-solid pouch battery prepared by the preparation method.

The present disclosure has the following beneficial effects. According to the defects of high gas production, synchronous solidified bubbles, low initial coulombic efficiency, poor cycling performance, and the like of an existing in-situ polymerization lithium-ion pouch battery obtained through one-step liquid injection polymerization, a process route of adding steps, such as secondary liquid injection, etc., is provided for a semi-solid lithium-ion pouch battery, for which an in-situ polymerization method is used, such that an electrolyte solution is fully formed before in-situ polymerization and is fully reacted, full production and exhaustion of gases are realized, and the aims of achieving bubble-free solidifying, improving the initial coulombic efficiency, and improving the cycling performance of a cell are achieved. By means of the above method, it is possible to technically convert academic research into actual products, and a semi-solid lithium-ion battery meeting the requirements of a real scenario may be produced.

### DETAILED DESCRIPTION OF THE EMBODIMENTS

### Example 1

An interface-free semi-solid pouch battery was prepared. A specific solution was as follows.

At S1, a ternary positive electrode plate was prepared through processes such as homogenate, coating, rolling, slitting, die cutting, etc., a graphite negative electrode plate was prepared through the processes such as homogenate, coating, rolling, slitting, die cutting, etc., and an aluminum oxide coated diaphragm was stacked with positive and negative electrodes.

At S2, an in-situ polymerization electrolyte solution precursor I was prepared; and 9 g of a reactive monomer vinylene carbonate (VC), 2 g of a crosslinking agent poly(ethylene glycol) diacrylate (PEGDA), 20 g of a small molecule plasticizer ethylene carbonate, 25 g of ethyl methyl carbonate, 25 g of diethyl carbonate, and 9 g of a lithium salt LiPF₆ were mixed and injected in an electrolyte solution bottle, and were fully stirred for 4 h, so as to obtain the in-situ polymerization electrolyte solution precursor I.

At S3, an in-situ polymerization electrolyte solution precursor II was prepared; and 0.25 g of an initiator 2,2′-azobis(2-methylpropionitrile) (AIBN), 15 g of a crosslinking agent poly(ethylene glycol) diacrylate (AIBN), 15 g of the small molecule plasticizer ethylene carbonate, 15 g of the ethyl methyl carbonate, 15 g of the diethyl carbonate, and 5 g of a lithium salt LiFSI were mixed and injected in an electrolyte solution bottle, and were fully stirred for 6 h, so as to obtain the in-situ polymerization electrolyte solution precursor II.

At S4, the positive and negative electrode plates and the diaphragm prepared in S1 were stacked, assembled, and dried, so as to prepare a dry battery cell without liquid injection.

At S5, the in-situ polymerization electrolyte solution precursor I prepared in S2 was injected in the dry battery cell prepared in S4 for first liquid injection, a liquid injection environmental dew point was controlled at −60° C., a vacuum degree was −98 kPa, and standing and soaking were performed at normal temperature for 48 h after liquid injection.

At S6, the injected cell prepared in S5 was subjected to formation, gas exhaustion, and high-temperature aging processes; and a formation condition included the following: a charging current was 0.01 C, and a charging time was 60 minutes; a gas exhaustion time was 20 s, a gas exhaustion vacuum degree was −98 kPa; and an aging temperature was 45° C., and an aging time was 120 h.

At S7, the in-situ polymerization electrolyte solution precursor II prepared in S3 was injected in the cell prepared in S6 for second liquid injection, the liquid injection environmental dew point was controlled at −60° C., and the vacuum degree was −98 kPa.

At S8, the injected cell prepared in S7 was placed in a 60° C. high-temperature environment for in-situ polymerization, a polymerization pressure was 0.2 MPa, the reaction was performed for 72 h, and the electrolyte solution was solidified.

At S9, the cell prepared in S8 was subjected to second formation, second gas exhaustion, standing, and capacity grading processes, so as to complete the preparation of a semi-solid battery. A charging current for second formation was 0.5 C, and a charging cutoff voltage was 4.2V. A second gas exhaustion time was 20 s, and a gas exhaustion vacuum degree was −98 kPa. The time for standing was 30 min.

At S10, capacity, cycle, and electrical performance, and safety tests such as acupuncture test and overcharging were performed on the prepared semi-solid battery, and the cell was disassembled to observe how many bubbles were there in the solidified electrolyte solution, finding that no bubble was observed in the solidified electrolyte solution.

### Example 2

The overall method was the same as Example 1, except that in S2, the reactive monomer was 18 g of poly(ethylene glycol) (n) monomethacrylate (PEGMA), the crosslinking agent was 2 g of poly(ethylene glycol) dimethacrylate (PEGDMA), the lithium salt was 15 g of LiCF₃O₃, and the small molecule plasticizer was 25 g of dimethyl carbonate, 20 g of N-methyl-2-pyrrolidone, and 20 g of propylene carbonate. In S3, the initiator was 0.5 g of benzoyl peroxide, the lithium salt was 7.9 g of LiTFSI, and the small molecule plasticizer was 16 g of the dimethyl carbonate, 14.1 g of the N-methyl-2-pyrrolidone, and 14.1 g of thepropylene carbonate.

Capacity, cycle, and electrical performance, and safety tests such as acupuncture test and overcharging were performed on the prepared semi-solid battery, and the cell was disassembled to observe how many bubbles were there in the solidified electrolyte solution, finding that no bubble was observed in the solidified electrolyte solution.

### Example 3

The overall method was the same as Example 1, except that in S2, the reactive monomer was 11 g of 1,3-dioxolane, the crosslinking agent was 1 g of pentaerythritol tetraacrylate, the lithium salt was 15 g of LiClO₄, and the small molecule plasticizer was 23 g of fluorinated ethylene carbonate, 25 g of dipropyl carbonate, and 25 g of polyethyleneglycol dimethyl ether. In S3, the initiator was 0.5 g of aluminum trifluoromethanesulfonate, there was no lithium salt, and the small molecule plasticizer was 16 g of the fluorinated ethylene carbonate, 23 g of the dipropyl carbonate, and 14.1 g of the polyethyleneglycol dimethyl ether.

Capacity, cycle, and electrical performance, and safety tests such as acupuncture test and overcharging were performed on the prepared semi-solid battery, and the cell was disassembled to observe how many bubbles were there in the solidified electrolyte solution, finding that no bubble was observed in the solidified electrolyte solution.

### Example 4

The overall method was the same as Example 1, except that in S2, the reactive monomer included vinylmethoxysilane and acrylonitrile; the precursor I lithium salt was LiBF₆, and the precursor II lithium salt was LiTFSI; the crosslinking agent was polyether polyacrylate; and the small molecule plasticizer included ethylene carbonate, dimethyl sulfoxide dimethoxyethane, and 7-butyrolactone, with the mass of each component added being the same as Example 1.

Capacity, cycle, and electrical performance, and safety tests such as acupuncture test and overcharging were performed on the prepared semi-solid battery, and the cell was disassembled to observe how many bubbles were there in the solidified electrolyte solution, finding that no bubble was observed in the solidified electrolyte solution.

### Example 5

The overall method was the same as Example 1, except that in S2, the reactive monomer included methyl vinyl sulfone and methyl methacrylate; the precursor I lithium salt was LiPF₆, and the precursor II lithium salt was LiFSI; the crosslinking agent was ethoxylated trimethylolpropane triacrylate; and the small molecule plasticizer included ethylene carbonate, dimethyl carbonate, and fluorinated ethylene carbonate, with the mass of each component added being the same as Example 1.

Capacity, cycle, and electrical performance, and safety tests such as acupuncture test and overcharging were performed on the prepared semi-solid battery, and the cell was disassembled to observe how many bubbles were there in the solidified electrolyte solution, finding that no bubble was observed in the solidified electrolyte solution.

### Example 6

The overall method was the same as Example 1, except that in S5 to S9, the liquid injection environmental dew point was −35° C., and the liquid injection vacuum degree was −20 kPa; and the gas exhaustion time was Is, and the gas exhaustion vacuum degree was −20 kPa.

Capacity, cycle, and electrical performance, and safety tests such as acupuncture test and overcharging were performed on the prepared semi-solid battery, and the cell was disassembled to observe how many bubbles were there in the solidified electrolyte solution, finding that no bubble was observed in the solidified electrolyte solution.

### Example 7

The overall method was the same as Example 1, except that in S5 to S9, conditions for first formation included: the charging current was 0.33 C, and the charging time was 120 minutes; and conditions for second formation included: the charging current was 0.01 C, and the charging cutoff voltage being 4.2V.

Capacity, cycle, and electrical performance, and safety tests such as acupuncture test and overcharging were performed on the prepared semi-solid battery, and the cell was disassembled to observe how many bubbles were there in the solidified electrolyte solution, finding that no bubble was observed in the solidified electrolyte solution.

### Example 8

The overall method was the same as Example 2, except that in S5 to S9, the high-temperature aging temperature was 80° C., and the time was 12 h; and the temperature during in-situ polymerization was 90° C., the polymerization time was 0.1 h, and the polymerization pressure was controlled at 500 MPa.

Capacity, cycle, and electrical performance, and safety tests such as acupuncture test and overcharging were performed on the prepared semi-solid battery, and the cell was disassembled to observe how many bubbles were there in the solidified electrolyte solution, finding that no bubble was observed in the solidified electrolyte solution.

### Comparative Example 1

A first liquid injection method was used to prepare a conventional interface-free semi-solid pouch battery. A specific solution was as follows.

S1 to S4 were the same as Example 1, liquid injection in S5 to S9 changed to first liquid injection, and a specific method was as follows.

At S5, the in-situ polymerization electrolyte solution precursor I prepared in S2 and the in-situ polymerization electrolyte solution precursor II prepared in S3 were mixed and stirred for 2 h at normal temperature until being uniform, and were injected in the dry cell prepared in S4; the liquid injection environmental dew point was controlled at −60° C., the vacuum degree was −98 kPa; and standing and soaking were performed at normal temperature for 48 h after liquid injection.

At S6, the injected cell prepared in S5 was placed in the 60° C. high-temperature environment for in-situ polymerization, the polymerization pressure was 0.2 MPa, the reaction was performed for 72 h, and the electrolyte solution was solidified.

At S7, the injected cell prepared in S6 was subjected to formation, gas exhaustion, and high-temperature aging processes; and the formation condition included the following: the charging current was 0.01 C, and the charging time was 60 minutes; the charging current for second formation was 0.5 C, and the charging cutoff voltage was 4.2V; the gas exhaustion time was 20 s, the gas exhaustion vacuum degree was −98 kPa; and the aging temperature was 45° C., and the aging time was 120 h.

Capacity, cycle, and electrical performance, and safety tests such as acupuncture test and overcharging were performed on the prepared semi-solid battery, and the cell was disassembled to observe how many bubbles were there in the solidified electrolyte solution, finding that bubbles were observed in the solidified electrolyte solution.

### Comparative Example 2

A liquid pouch battery was prepared. A specific solution was as follows.

At S1, a ternary positive electrode plate was prepared by using a lithium-ion battery preparation process: homogenate, coating, rolling, slitting, and die cutting; a graphite negative electrode plate was prepared by using the lithium-ion battery preparation process: homogenate, coating, rolling, slitting, and die cutting; and an aluminum oxide coated separator was stacked with positive and negative electrodes.

At S2, the positive and negative electrode plates and the separator prepared in S1 were stacked, assembled, and dried, so as to prepare a dry battery cell without liquid injection.

At S3, an electrolyte solution (EC:EMC:DEC=1:1:1, LiPF₆ was 1 mol/L) was prepared and injected in the dry battery cell prepared in S2 for liquid injection, a liquid injection environmental dew point was controlled at −60° C., a vacuum degree was −98 kPa; and standing and soaking were performed at normal temperature for 48 h after liquid injection.

At S4, the injected cell prepared in S3 was subjected to formation, gas exhaustion, and high-temperature aging processes; and a formation condition included the following: a charging current was 0.01 C, and a charging time was 60 minutes; a charging current for second formation was 0.5 C, and a charging cutoff voltage was 4.2V; a gas exhaustion time was 20 s, a gas exhaustion vacuum degree was −98 kPa; and an aging temperature was 45° C., and an aging time was 120 h.

At S5, capacity, internal resistance, cycle, rate, high-temperature storage, and other electrical performance, and safety tests such as acupuncture test and overcharging were performed on the prepared liquid lithium-ion battery, and the cell was disassembled to observe how many bubbles were there in the solidified electrolyte solution, finding that no bubble was observed in the solidified electrolyte solution.

### Comparative Example 3

The overall method was the same as Example 1, except that in S2, the reactive monomer was 5 g of VC, the crosslinking agent was 0.5 g of PEGDA, and materials and mass of other components added were the same as Example 1.

Capacity, cycle, and electrical performance, and safety tests such as acupuncture test and overcharging were performed on the prepared semi-solid battery, and the cell was disassembled to observe how many bubbles were there in the solidified electrolyte solution, finding that no bubble was observed in the solidified electrolyte solution.

### Comparative Example 4

The overall method was the same as Example 1, except that in S3, the initiator was 0.05 g, and materials and mass of other components added were the same as Example 1.

Capacity, cycle, and electrical performance, and safety tests such as acupuncture test and overcharging were performed on the prepared semi-solid battery, and the cell was disassembled to observe how many bubbles were there in the solidified electrolyte solution, finding that no bubble was observed in the solidified electrolyte solution.

### Comparative Example 5

The overall method was the same as Example 1, except that the lithium salt in S2 was 5 g, the lithium salt in S3 was 1 g, and materials and mass of other components added were the same as Example 1.

Capacity, cycle, and electrical performance, and safety tests such as acupuncture test and overcharging were performed on the prepared semi-solid battery, and the cell was disassembled to observe how many bubbles were there in the solidified electrolyte solution, finding that no bubble was observed in the solidified electrolyte solution.

### Test Example 1

At S1, a cycle test was performed according to the national standard GB/T31484-2015. Specific steps were shown as follows.
(a) Discharging was performed to 2.75V at a constant current of 1Iᵢ (A).
(b) Standing was performed for 30 min.
(c) Charging was performed to 4.2V at the constant current of 1Iᵢ (A), and charging was performed to 0.05I₁ (A) at a constant voltage.
(d) Standing was performed for 30 min.
(e) Discharging was performed to 2.75V at the constant current of 1I₁ (A).
(f) 100 to 1000 cycles were continuously performed according to (b)~(e).

At S2, an acupuncture test was performed according to the national standard GB/T31485-2015. Specific steps were shown as follows.
(a) The battery was charged to 4.2V at a constant current of 1Iᵢ (A), and was charged to 0.05I₁ (A) at a constant voltage.
(b) A Φ5 mm high-temperature resistant steel needle (a cone angle of a needle tip was 450 to 600, and the needle was smooth in surface and free of rust, oxidation layer, and oil stains) penetrated in a direction perpendicular to a battery plate at a speed of (25±5)mm/s, a penetration position should be close to a geometric center of the surface being pierced, and the steel needle remained in the battery.
(c) Observation was performed for 1 h.

TABLE 1
Statistics of battery test results of examples and comparative examples

| | | Were | | | | |
|---|---|---|---|---|---|---|
| | Was an | bubbles | | Battery | | |
| | electrolyte | present in | | initial | | |
| | solution | the | Battery | coulombic | | |
| | polymerized | electrolyte | capacity | efficiency | Electrical | |
| | and solidified | solution | (Ah) | (%) | performance | Safety |
| Example 1 | Yes | None | 40.66 | 84.3 | 800 cycles | Needle |
| | | | | | | piercing |
| | | | | | | through |
| Example 2 | Yes | None | 40.46 | 84.2 | 800 cycles | Needle |
| | | | | | | piercing |
| | | | | | | through |
| Example 3 | Yes | None | 40.03 | 83.1 | 800 cycles | Needle |
| | | | | | | piercing |
| | | | | | | through |
| Example 4 | Yes | None | 39.40 | 81.5 | 800 cycles | Needle |
| | | | | | | piercing |
| | | | | | | through, with |
| | | | | | | lower |
| | | | | | | temperature |
| | | | | | | rise |
| Example 5 | Yes | None | 39.11 | 80.8 | 800 cycles | Needle |
| | | | | | | piercing |
| | | | | | | through, with |
| | | | | | | lower |
| | | | | | | temperature |
| | | | | | | rise |
| Example 6 | Yes | Small | 37.06 | 79.4 | 500 cycles | Needle |
| | | amount | | | | piercing |
| | | | | | | through |
| Example 7 | Yes | None | 39.20 | 81.1 | 600 cycles | Needle |
| | | | | | | piercing |
| | | | | | | through |
| Example 8 | Yes | Small | 35.34 | 76.9 | 400 cycles | Needle |
| | | amount | | | | piercing |
| | | | | | | through |
| Comparative | Yes | Present | 31.55 | 70.5 | 200 cycles | Needle |
| Example 1 | | | | | | piercing |
| | | | | | | through |
| Comparative | No | None | 40.43 | 83.7 | 800 cycles | Needle not |
| Example 2 | | | | | | piercing |
| | | | | | | through |
| Comparative | No | None | 39.70 | 82.4 | 700 cycles | Needle not |
| Example 3 | | | | | | piercing |
| | | | | | | through |
| Comparative | No | None | 40.19 | 82.6 | 700 cycles | Needle not |
| Example 4 | | | | | | piercing |
| | | | | | | through |
| Comparative | Yes | None | 21.58 | 74.2 | Low initial | Needle |
| Example 5 | | | | | capacity, no | piercing |
| | | | | | more cycle | through |
| | | | | | tests | |

Result analysis: from Examples 1 to 5, it might be learned that, the in-situ polymerization process route of the present disclosure was suitable for a plurality of in-situ polymerization systems, such that the process route was wide in application range. The present disclosure might use a lithium salt system, or might also use two lithium salt systems (a small amount of a lithium salt additive did not belong to the lithium salt system). The in-situ polymerization process route of the present disclosure was highly compatible with existing lithium-ion battery production lines, and the required semi-solid battery might be prepared without the need for custom-made special devices.

By comparing the results in Examples 4 and 5 with Example 1, it might be learned that, the present disclosure might be extended to an in-situ polymerization system containing two monomers. The two polymer systems prepared interpenetrated, further improving the safety of the semi-solid polymer battery.

By comparing the results in examples with Comparative Example 2, it might be learned that, compared with a conventional liquid lithium-ion battery process route, in the in-situ polymerization process route of the present disclosure, the safety of the semi-solid battery was greatly improved, and tests such as acupuncture test and high-voltage overcharge that the liquid batteries could not pass might be all passed by the semi-solid battery of the present disclosure.

What is claimed is:

1. A method for preparing a semi-solid pouch battery, wherein the semi-solid pouch battery comprising a dry cell, and the preparation method comprising the following steps:
(1) performing first liquid injection in a dry cell, and injecting an electrolyte solution precursor I, wherein the electrolyte solution precursor I comprising a reactive monomer, a crosslinking agent, a small molecule plasticizer, and a lithium salt;
(2) performing first formation, and then performing first gas exhaustion;
(3) performing second liquid injection, and injecting an electrolyte solution precursor II, wherein the electrolyte solution precursor II comprising an initiator and a small molecule plasticizer, and comprising or does not comprising a lithium salt; and the reactive monomer and the crosslinking agent undergo in-situ polymerization under the action of the initiator; and
(4) performing second formation, and then performing second gas exhaustion.

2. The method for preparing a semi-solid pouch battery according to claim 1, wherein the reactive monomer comprising at least one of the following: vinyl acetate, dimethyl allyl dicarboxylate, diethyl allylmalonate, dimethallyl carbonate, 1,4-butanediol diacrylate, hexamethylene diacrylate, methyl methacrylate, butyl methacrylate, vinylene carbonate, 4-vinyl-1,3-dioxolan-2-one, methyl vinyl sulfone, ethyl vinyl sulfone, ethoxylated trimethylolpropane triacrylate, pentaerythritol triacrylate, pentaerythritol tetraacrylate, dipentaerythritol hexaacrylate, dipentaerythritol hexaacrylate, acrylamide, N,N-methylenebisacrylamide, caprolactam, 2-pyrrolidinone, acrylonitrile, 2-carbonitrile ethyl acrylate, 2-carbonitrile-2-butyl acrylate, 2-carbonitrile-3,3-isooctyl diphenyl acrylate, 1-cyclohexene-1-acetonitrile, hexafluorobutyl methacrylate, trifluoroethyl methacrylate, poly(ethylene glycol) methacrylate, polyethylene glycol dimethacrylate, poly(ethylene glycol) diacrylate, ethoxyethyl acrylate, polyethylene glycol, 1,3-dioxolane, 1,4-dioxane, vinylmethoxysilane, 2-(trimethylsiloxy)ethyl methacrylate, triethylcyclotriosiloxane, or tri(2-methoxyethoxy)vinylsilane;
the crosslinking agent comprising at least one of the following: poly(ethylene glycol) diacrylate, poly(ethylene glycol) dimethacrylate, trimethylolpropane trimethacrylate, pentaerythritol tetraacrylate, pentaerythritol triacrylate, ethoxylated trimethylolpropane triacrylate, or polyether polyacrylate;
the initiator comprising at least one of the following: 2,2′-azobis(2-methylpropionitrile), 2,2′-azobis(2,4-dimethyl)valeronitrile, dimethyl 2,2′-azobis(2-methylpropionate), benzoyl peroxide, tert-butyl peroxybenzoate, 2-butanone peroxide, aluminum trifluoromethanesulfonate, magnesium trifluoromethanesulfonate, lithium bis(fluorosulfonyl)imide, or tin(II) trifluoromethanesulfonate;
the lithium salt comprising at least one of the following: LiBF₄, LiBF₆, LiAsF₆, LiPF₆, LiClO₄, LiFSI, LiTFSI, LiB(C₆H₅)₄, LiAlCl₄, LiBr, LiCF₃SO₃, LiN(CF₃SO₂)₂, or LiC(CF₃SOSO₂)₃; and
the small molecule plasticizer comprising at least one of the following: ethylene carbonate, propylene carbonate, ethyl methyl carbonate, diethyl carbonate, dimethyl carbonate, fluorinated ethylene carbonate, dipropyl carbonate, dimethyl sulfoxide dimethoxyethane, N-methyl-2-pyrrolidone, 7-butyrolactone, or polyethylene glycol dimethyl ether.

3. The method for preparing a semi-solid pouch battery according to claim 1, wherein a mass fraction of the reactive monomer in the electrolyte solution precursor I is 10% to 18%;
a mass fraction of the crosslinking agent in the electrolyte solution precursor I is 1% to 2.2%;
a mass fraction of the initiator in the electrolyte solution precursor II is 0.50% to 0.95%;
a mass fraction of the lithium salt in the electrolyte solution precursor I is 10% to 15%;
a mass fraction of the lithium salt in the electrolyte solution precursor II is 0% to 15%; and
other components in the precursor I and the precursor II are the small molecule plasticizers.

4. The method for preparing a semi-solid pouch battery according to claim 1, wherein the electrolyte solution precursor I and the electrolyte solution precursor II are added based on a mass ratio of (1.8~1.9):1.

5. The method for preparing a semi-solid pouch battery according to claim 1, wherein in step (3), a temperature during in-situ polymerization is 60 to 90° C., a polymerization time is 0.1 to 72 h, and a polymerization pressure is controlled at 0.2 MPa to 500 MPa.

6. The method for preparing a semi to solid pouch battery according to claim 1, wherein conditions for first formation comprising: a charging current being 0.01 C to 0.33 C, and a charging time being 60 minutes to 120 minutes; and
conditions for second formation comprising: a charging current being 0.01 C to 0.5 C, and a charging cutoff voltage being a rated voltage.

7. The method for preparing a semi to solid pouch battery according to claim 1, wherein gas exhaustion times for first gas exhaustion and second gas exhaustion are 1 to 20 s, and a gas exhaustion vacuum degree is between −98 kPa and −20 kPa;
high-temperature aging is performed after first gas exhaustion, a high-temperature aging temperature is 45° C. to 80° C., and a time is 12 to 120 h; and
standing is performed after second gas exhaustion, and a standing time is 1 to 30 min.

8. The method for preparing a semi-solid pouch battery according to claim 1, wherein environmental dew points during first liquid injection and second liquid injection are controlled at −60° C. to −35° C., a vacuum degree is −98 kPa to −20 kPa, and standing is performed at normal temperature for at least 48 h after first liquid injection.

9. A semi-solid pouch battery prepared by the preparation method according to claim 1.

10. The method for preparing a semi-solid pouch battery according to claim 2, wherein a mass fraction of the reactive monomer in the electrolyte solution precursor I is 10% to 18%.

11. The method for preparing a semi-solid pouch battery according to claim 2, wherein a mass fraction of the crosslinking agent in the electrolyte solution precursor I is 1% to 2.2%.

12. The method for preparing a semi-solid pouch battery according to claim 2, wherein a mass fraction of the initiator in the electrolyte solution precursor II is 0.50% to 0.95%.

13. The method for preparing a semi-solid pouch battery according to claim 2, wherein a mass fraction of the lithium salt in the electrolyte solution precursor I is 10% to 15%.

14. The method for preparing a semi-solid pouch battery according to claim 2, wherein a mass fraction of the lithium salt in the electrolyte solution precursor II is 0% to 15%.
